(19) United States
(12) Patent Application Publication
(10) Pub. No.: US 2006/0197834 A1
(43) Pub. Date: Sep. 7, 2006

(54) Matrix home studio

(76) Inventor: Dorin Balanica, Longueuil (CA)

Correspondence Address: DORIN BALANICA, 398 Rue Rouville, Longueuil, QC, J4K 2W4, CA

(21) Appl. No.: 11/347,239

(22) Filed: Feb. 6, 2006

Related U.S. Application Data
(60) Provisional application No. 60/659,062, filed on Mar. 7, 2005.

(51) Int. Cl. H04N 7/18

(52) U.S. Cl. 348/114; 348/705

(57) ABSTRACT

A system for simultaneous viewing of a plurality of channels that allow a channel instant transfer on the main monitor and includes a plurality of displays, an audio video signal booster splitter, power supply and a remote control controlling functions of the matrix multi display and main monitor. When the user want to watch a particular channel from the matrix of multiple channel displays, he operates a single button, corresponding to that channel display and the remote control transmits a signal to the main monitor to instantly display the same channel audio video information.

I hereby claim the priority of my earlier filled provisional application No. 60/659,062, Date Mar. 7, 2005

### BACKGROUND OF THE INVENTION

1. Field of the Invention

The invention relates generally to electronic components but more particularly to a multiple channel viewing display with transfer capability to a master monitor by way of a remote control.

2. Background of the Invention

There exists several commercial systems comprised of banks of monitors for simultaneous viewing, may they be for the purpose of TV stations or for security monitoring and industrial processes monitoring, surveillance and so on.

For the consumers market, there are various schemes provided by cable or satellite broadcasting companies which allow for a viewer to watch several channels simultaneously on a single monitor. The viewer can then select the channel of his choice. Because of the multitude of channels being displayed simultaneously, no sound is provided, lest it creates dissonance with 20-30 different sounds coming in simultaneously.

### SUMMARY OF THE INVENTION

It is a main advantage of this invention to provide for a series of separate monitors mounted on a rack so as to create a matrix and allowing a channel selected from the plurality of channels shown and displayed on a user's regular TV main monitor.

In order to do so, the invention comprises a specially designed remote control to control a matrix of monitors and a TV main monitor. A signal booster amplifies the signal for display on the matrix of monitors. A separate power supply provides power to the matrix of monitors.

Alternatively, a single monitor can display the matrix of images, as would be displayed on several separate monitors, allowing a channel selected from the plurality of channels shown to be displayed on a user's regular TV main monitor, by way of a remote control.

If a user has a very large screen, both the matrix and the main image could be shown on a single TV set with the main image being suitably large for easy viewing and with the possibility of shutting off the matrix to watch only the main image to its largest possible size.

With today's need for more information more quickly, the only way to go about it is to be fed several channels simultaneously and select the one that appears the most interesting at the moment. It allows the viewer to scan across a plurality of channels much like a reader would scan across a plurality of books, magazines and newspapers to glean the highlights. This system can have applications in education where several inputs can be filtered. Museums, exhibits, points of sale can also be likely targets for such a product.

The foregoing and other objects, features, and advantages of this invention will become more readily apparent from the following detailed description of a preferred embodiment with reference to the accompanying drawings, wherein the preferred embodiment of the invention is shown and described, by way of examples. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF THE PREFERRED EMBODIMENT

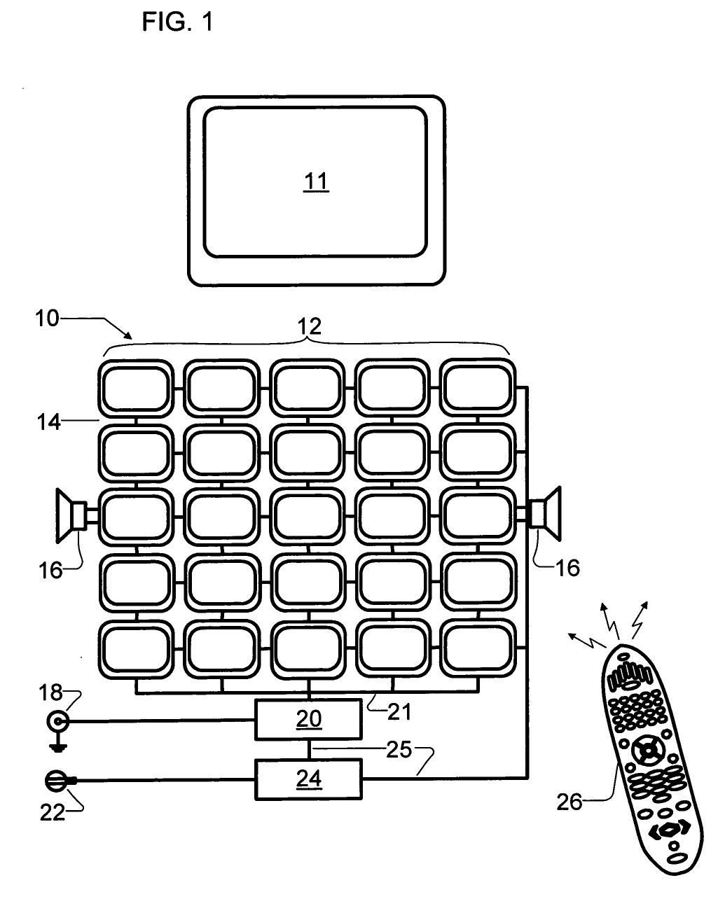

FIG. 1 Schematic view of the monitor matrix with the remote control.

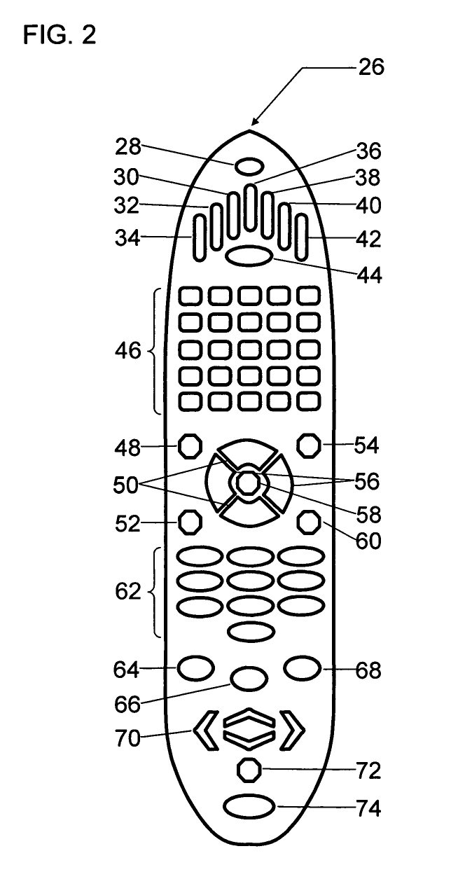

FIG. 2 Plan view of the remote control.

### DETAILED DESCRIPTION OF THE PREFERRED EMBODIMENT

As illustrated in FIG. 1, a matrix home studio 10 consists of individual monitors 12 mounted on a rack 14. Optional speakers 16 provide sound for a selected channel from the displayed channels. A signal outlet 18 feeds a signal booster splitter 20 which in turns feeds the matrix home studio 10 by way of signal cables 21. A power outlet 22 provides power to a power supply 24 which provides power to the signal booster splitter 20 and the matrix home studio 10 by way of power cables 25. A remote control 26 controls various function of the matrix home studio 10 and of the TV main monitor 11.

As represented in FIG. 2, the remote control 26 has buttons to control the usual functions found on existing remote controls as well as specific functions for controlling the matrix home studio 10 (FIG. 1) and the main TV monitor 11 (FIG. 1) and they as described thusly:

Power 28 to turn the matrix home studio 10 on /off.

AUX 30 for accessing an auxiliary piece of equipment.

CATV/SAT selector 32.

VCR access 34.

Main TV monitor access 36.

HI-FI sound 38.

DVD/VCD access 40.

AVI/AVD access 42.

Matrix command 44.

Each button 46 corresponds to a monitor 12 (FIG. 1) and serves for instant transfer of a selected channel live image and sound to the main TV monitor 11 (FIG. 1).

Mute 48.

Channel up/down, volume and menu options 50 used in conjunction with the instant transfer to main monitor, buttons 46 allows for selecting channel from a particular monitor 12 (FIG. 1) such as listening to the sound of that particular monitor on the matrix's optional speakers 16 (FIG. 1), all functions available on the remote control 26 can be applied to selected monitor 12 (FIG. 1).

Quick view returns to previously selected channel 52.

MTS/SAP multi channel sound 54.

Volume control and menu options 56.

Access menu options 58.

Picture mode 60.

Direct channel selector by number input 62.

Onscreen display 64.

Favorites matrix channels configurations 66.

Sleep timer 68.

Operating menu controls for video and audio components 70.

Closed captioning 72.

Voice recognition activation 74.

The invention claimed is:

1. A matrix home studio for simultaneous viewing of a plurality of channels comprising:
a plurality of displays, an audio video signal booster splitter which in turns feeds said matrix home studio by way of signal cables;
a power supply to provide power to a said audio video signal booster splitter and said matrix home studio by way of power cables;
a remote control to control various functions of said matrix home studio;
said remote control having unique functions consisting of main TV access, matrix home studio command, instant transfer to main TV with each button corresponding to a monitor, channel up/down, volume and menu options used in conjunction with said instant transfer to main TV monitor buttons so as to allow for selecting channel from a particular monitor. Voice recognition activation is alternatively used to control various functions of said matrix home studio.
